(19) United States
(12) Patent Application Publication
(10) Pub. No.: US 2009/0276762 A1
(43) Pub. Date: Nov. 5, 2009

(54) Method for the computer-assisted optimization of the resource utilization of a program

(76) Inventor: Michael Pönitsch, München (DE)

Correspondence Address: HARNESS, DICKEY & PIERCE, P.L.C., P.O.BOX 8910, RESTON, VA, 20195, US

(21) Appl. No.: 12/311,356

(22) PCT Filed: Sep. 26, 2007
(86) PCT No.: PCT/EP2007/060180

§ 371 Date: Mar. 27, 2009

(30) Foreign Application Priority Data
Sep. 26, 2006 (DE) 10 2006 046 201.7

(51) Int. Cl. G06F 9/44

(52) U.S. Cl. 717/127; 717/130

(57) ABSTRACT

In accordance with 37 C.F.R. §1.125, a substitute specification has been included in lieu of substitute paragraphs in connection with the present Preliminary Amendment. The substitute specification is submitted in clean form, attached hereto, and is accompanied by a marked-up version showing the changes made to the original specification. The changes have been made in an effort to place the specification in better form for U.S. practice. No new matter has been added by these changes to the specification. Further, the substitute specification includes paragraph numbers to facilitate amendment practice as requested by the U.S. Patent and Trademark Office.

### PRIORITY STATEMENT

This application is the national phase under 35 U.S.C. § 371 of PCT International Application No. PCT/EP2007/060180 which has an International filing date of Sep. 26, 2007, which designated the United States of America and which claims priority to German Application No. 10 2006 046 201.7 which has a filing date of Sep. 29, 2006, the entire contents of which is hereby incorporated herein by reference.

### FIELD OF THE INVENTION

At least one embodiment of the invention generally relates to a method for the computer-aided optimization of the resource utilization of a program comprising at least one separately executable program module when the program is executed on an, in particular distributed, computer system.

### BACKGROUND

With distributed computer systems having a plurality of hardware and software components there often arises the problem during the development and commissioning phase that the system does not deliver adequate performance. The cause of this resides in the fact that the interaction of the hardware and software components is not optimal. When the problem is analyzed it often transpires that individual components exhibit satisfactory performance when considered independently. As a rule it is not, however, possible to predict what impact an individual software component may have on other hardware and/or software components. In particular it cannot be recognized what effect an individual software component may have on the performance of the overall distributed computer system.

In order to optimize the utilization of resources, application instances (called “use cases”) of the overall distributed computer system are analyzed in the course of what is termed an integration or system test. During this test, total runtimes, response times of individual hardware and software components, the resource utilization of processing units, memory, input/output usage, etc. are measured usually using what are called profilers. This is carried out once for the overall system and once for individual hardware and/or software components.

Profilers are programming tools which analyze the runtime behavior of a program. With the aid of the profiler it is possible, by analyzing and comparing running programs, to identify and rectify problem areas of the program or of individual program parts. Profilers are most commonly used for counting and measuring calls and iterations of the program parts of the program. A further aspect is the tracing of memory usage by a program. By way of a profiler it is possible e.g. to optimize the usage and resource consumption of the available working memory. Where applicable, bugs in the program which prevent unused memory areas from being released can be pinpointed. Furthermore, profilers can visually edit program parts executing in parallel in order to facilitate the analysis.

Specific program parts or all program parts are extended set of instrumentation. This means that interruption markers (called interrupts) are inserted into the program section or sections or program code which signal to the profiler during the program run that the section is currently being processed. The time between the calls of the analysis points (as well as the memory behavior as a difference compared to a previous pass) can be incorporated as runtime values into the result of the analysis. The instrumentation changes the program in such a way that analysis data can be computed.

At the same type there are different types of instrumentation: a manual instrumentation by extending the source text by commands which calculate the runtime; programs extended by compiler options and thus receiving profiler marks; subsequent modification of compiled programs by insertion of marks; runtime instrumentation, in which the stored program remains untouched, and the profiler marks are added prior to the program's execution in a working memory.

During the optimization of the resource utilization there often arises the problem that although a program part actually requests fewer resources as a result of an improvement to the program code of said program part, the resource utilization of the overall program is either not or only marginally improved thereby.

### SUMMARY

At least one embodiment of the present invention is directed to a method which enables an optimization of the resource utilization of an overall program that executes on an, in particular distributed, computer system.

In at least one embodiment, an inventive method for the computer-aided optimization of the resource consumption of a program comprising at least one separately executable program part when the program executes on an, in particular distributed, computer system comprises:
initial determination of the resource utilization during the execution of the program;
extension of the program code of the at least one separately executable program part by at least one benchmark program such that a change in the resource utilization of the program part results therefrom;
measurement of the resource utilization of the program;
repeated variation of the at least one benchmark program in the at least one separately executable program part and measurement of the resource utilization of the program until a minimum resource utilization of the program is present.

With the method according to at least one embodiment of the invention, the resource utilization of individual executable program parts can be selectively varied during a system test of the distributed computer system by the insertion and sequential variation of the benchmark program. In the process the respective effects on the resource utilization initially of the subprogram and finally of the (overall) program are determined. In this case the modification is not restricted e.g. as in the case of instrumentation profiling, to the adding of analysis code which does not affect the resource utilization of the program. Rather, code is added in such a way that a significant change in the resource utilization can be identified such that effects on other program parts or hardware or software components occur. This approach permits the performance of the distributed computer system to be determined in its totality and in its individual components in a single system test. It also allows statistics to be generated concerning the degree of dependence of the resource utilization or performance on individual program parts. In this way it becomes possible to subject program parts having a significant dependence to an optimization in a targeted manner.

In one embodiment one or more of the following parameters are measured as a benchmark for resource utilization:
the total runtime of the program;
a memory utilization of the computer system;
a usage of inputs and/or outputs;
a utilization of at least one processing unit (CPU) of the computer system.

In one embodiment a change in the runtime of the at least one program part, in particular an increase, is effected by the benchmark program in the at least one program part. According to this variant a wait loop which lengthens the duration of the at least one program part in a defined manner is inserted into the program code of the program part.

In another variant a utilization of the at least one processing unit of the distributed computer system is modified, in particular increased, by the benchmark program in the at least one program part.

In a further embodiment at least one input and/or one output of the distributed computer system are/is used by the benchmark program in the at least one program part.

In a further embodiment a memory utilization of the distributed computer system caused by the at least one program part is modified, in particular increased, by the benchmark program in the at least one program part.

Depending on the embodiment of the benchmark program the resource utilization of the relevant program part can be influenced in this way.

The extension of the program code of the at least one program part by at least one benchmark program takes place either at machine code level or at source code level.

The extension of the program code of the at least one program part by at least one benchmark program beneficially starts with the program part having the greatest runtime. It is advantageous in this case if the extension of the program code of the at least one program part by at least one benchmark program takes place sequentially. By this means it is possible in a relatively short time to obtain an overview of which program parts exhibit a strong dependence in relation to the performance of the (overall) program in order to optimize said parts in a targeted manner. According to a further embodiment a profiling can be carried out in order to determine the runtime of at least some of the program parts and/or to determine the memory usage and/or to determine a concurrency.

According to a further embodiment the addition of the at least one benchmark program in the at least one program part is formed by the provisioning of an aspect.

Determining the resource utilization by providing an aspect is beneficially carried out in a computer-aided manner.

### BRIEF DESCRIPTION OF THE DRAWINGS

The invention is explained in more detail below with reference to an example embodiment in the drawing, in which:

FIG. 1 shows a schematic program execution sequence of an example use case in which a plurality of program parts of a program are executed in different components of a distributed computer system in a still unchanged form, and

FIG. 2 shows a schematic program execution sequence of the use case illustrated in FIG. 1 in which the program sections are varied by way of additional program code.

### DETAILED DESCRIPTION OF THE EXAMPLE EMBODIMENTS

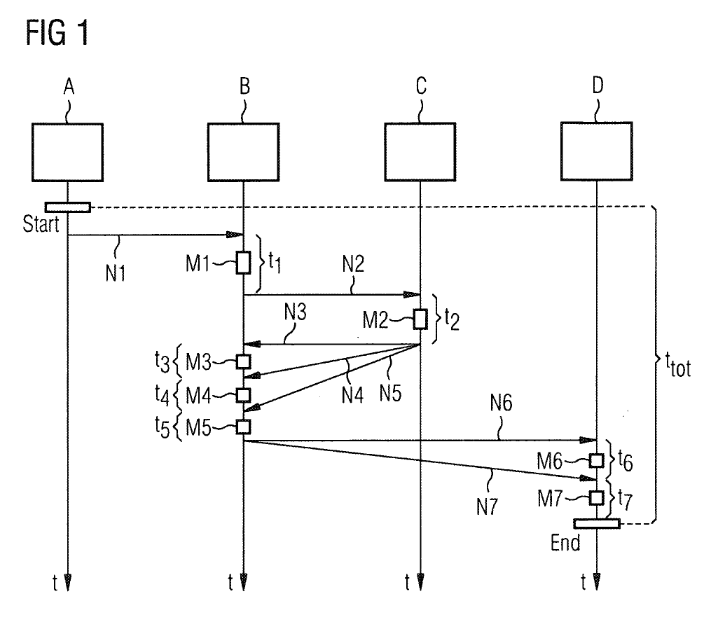

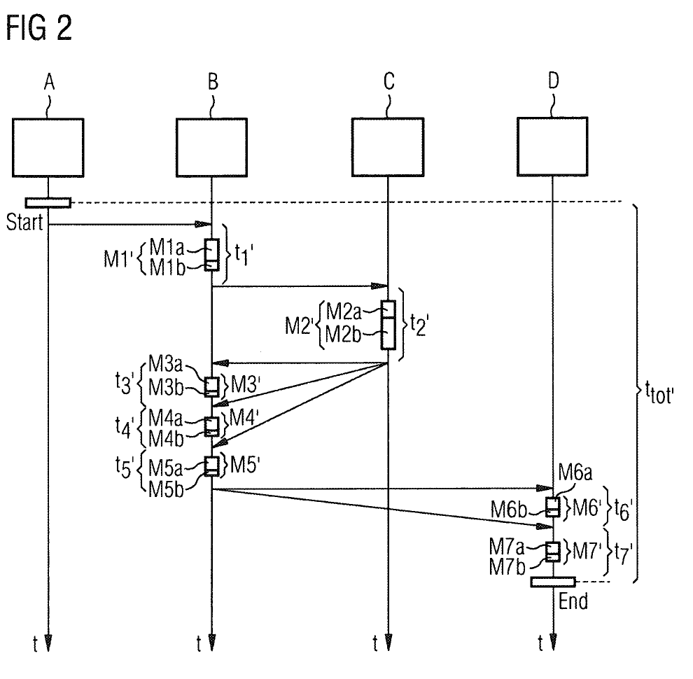

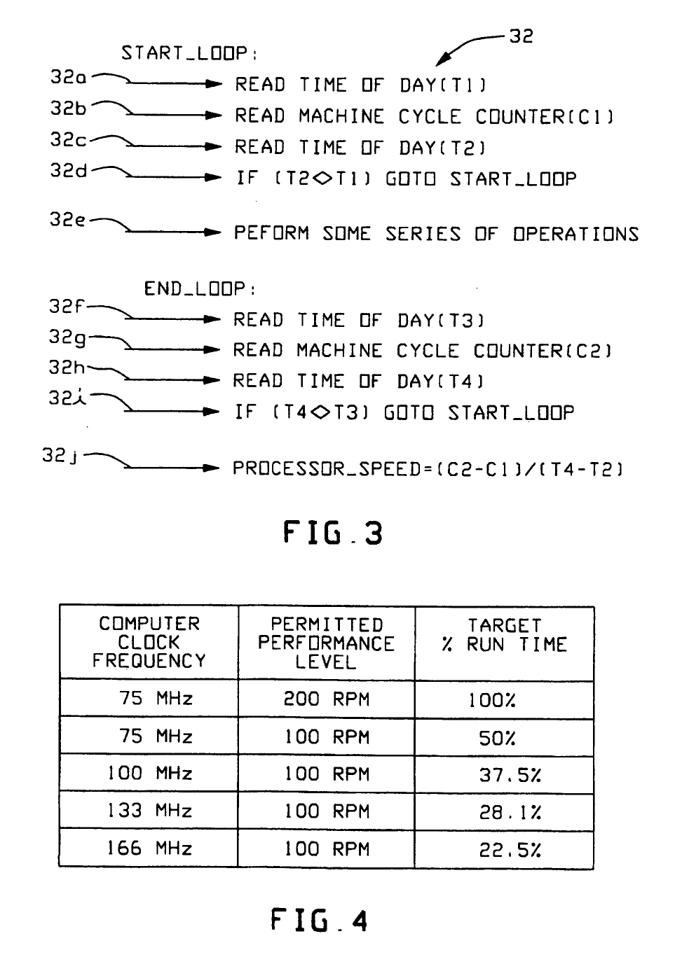

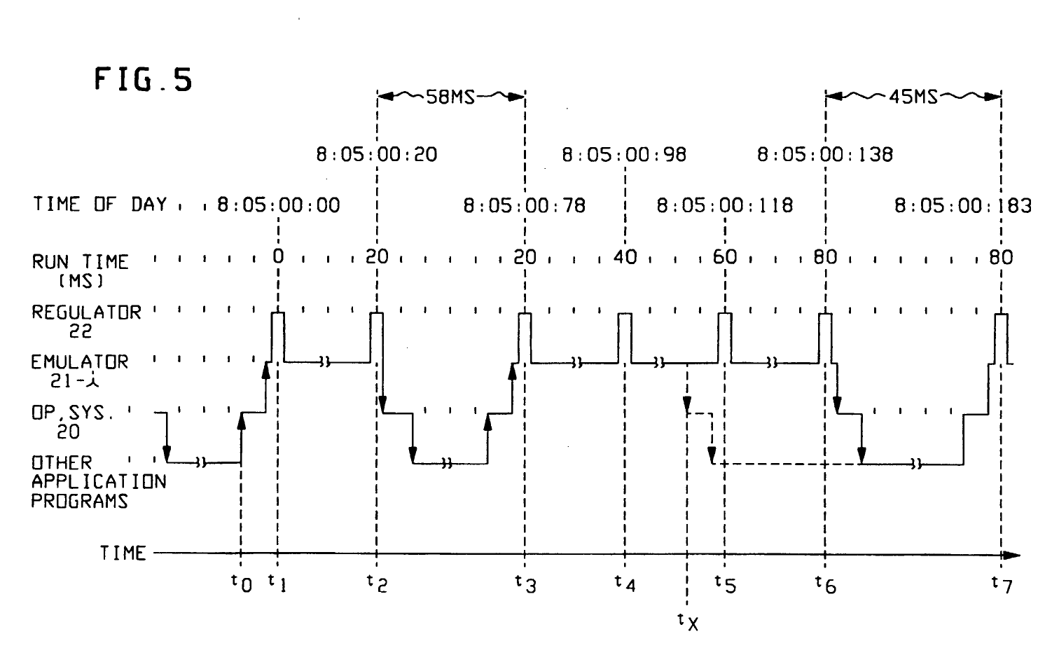

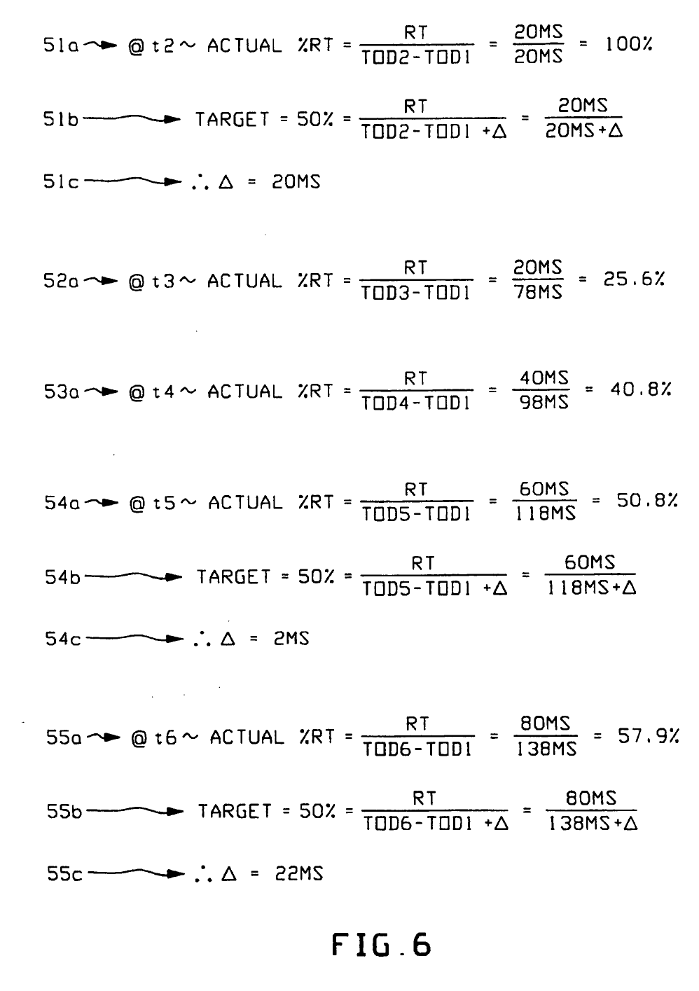

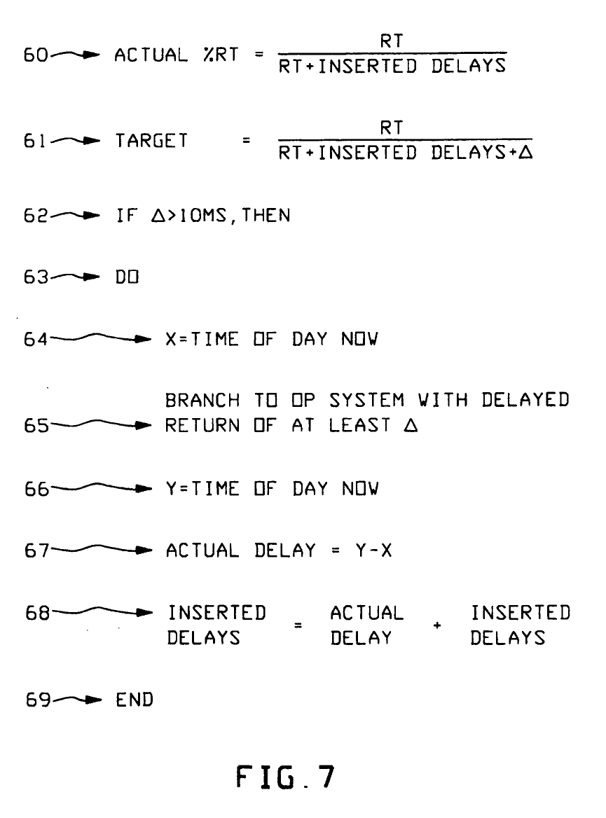

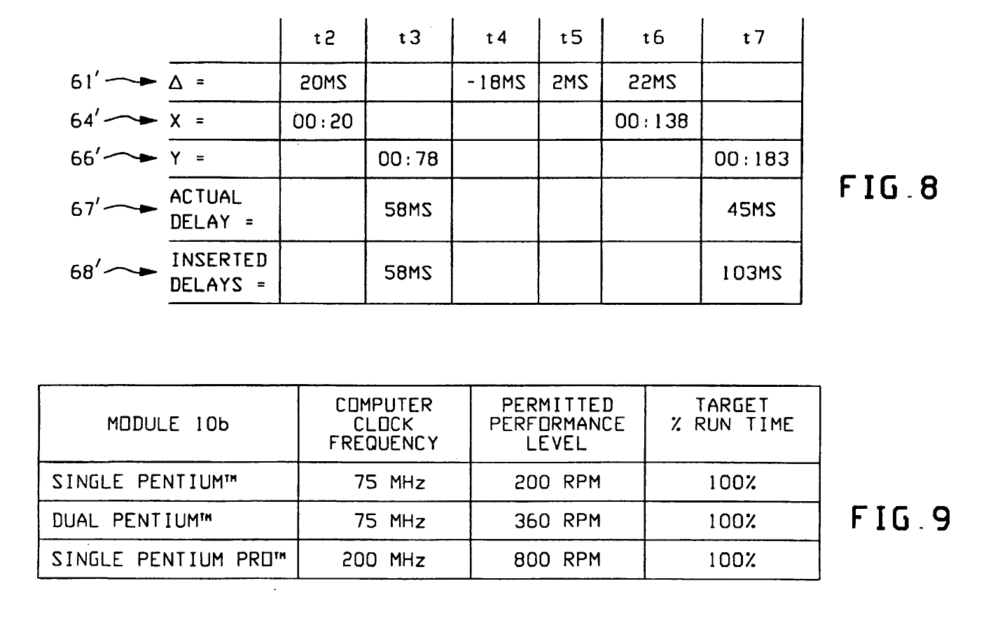

FIGS. 1 and 2 show a fire alarm system as a use case. The system comprises software components A, B, C, D which are stored for example by different computers and/or devices (e.g. sensors and/or display elements, etc.) of an e.g. distributed computer system for execution in each case. Software component A can be, for example, a fire detector. The software component B is assigned to a fault incident computer (called an “incident server”) which receives an incident message from the software component A. The software component C represents, for example, a control and analysis unit which analyzes incident messages relayed to it. In this use case, the software component D represents, for example, a display unit on which messages relating to an incident can be displayed. The software components B and C can be provided, for example, on a single computer.

When a program is executed on the distributed computer system, program parts M1, . . . , M7 on the different software components A, B, C, D of the distributed computer system are executed in a sequence predefined by the program code. The times taken for the execution of a respective program part Ml, . . . M7 are identified in the figures by t₁, . . . , t₇. The execution of the entire program from a start to an end takes tₜₒₜ.

In this case the execution sequence takes place by way of example as follows. A message N1 is issued to the software component B by the software component A. The software component B thereupon executes the program part M1, for which the time t₁ is required. The result of the execution of the program part M1 is a message N2 to the software component C of the distributed computer system. Said component performs for example an analysis in the program part M2. The time taken for the execution of the program part M2 amounts to t₂. As the result of the processing of the program part M2, messages N3, N4, N5 are transmitted to the software component B which in the example embodiment sequentially executes the program parts M3, M4 and M5, for example. For this, the times t₃, t₄ and t₅ are required. Contrary to what is shown in the drawing, the program parts M3, M4, M5 could also be executed in parallel by the software component B. At the end of the program part M5, messages N6 and N7 are transmitted to the software component D. The latter first executes a program part M6 and then a program part M7. The time t₆ is required to execute the program part M6, the time t₇ to execute the program part M7. In the program parts M₆, M₇, a corresponding message about the occurrence of a fire source, etc. can be output on the display, for example. The time tₜₒₜ is required for the execution of the entire program.

The respective times taken by the program parts M1, . . . , M7 as well as the total runtime tₜₒₜ can be measured for example by means of instrumentation profiling. In this case a timer start and timer stop sequence can be incorporated into the machine code or bytecode of the program part awaiting execution at the beginning and end of each program part. This enables the duration of the call of each program part to be measured.

In the case of the program parts M1, . . . , M7, if the program is present in the form of an object-oriented program code, the calls can be, for example, methods, i.e. functions or subcalls, of the objects.

In order to optimize the resource utilization, in particular the total runtime tₜₒₜ, the memory utilization, the use of inputs and outputs of individual computers of the distributed computer system, etc., a targeted varying of the individual program parts M1, . . . , M7 is carried out, with the effects of the variations on the total runtime tₜₒₜ being measured. For this purpose the program parts are at least partially extended by at least one benchmark program in each case. This is illustrated in FIG. 2. In the example embodiment, each program part is supplemented by precisely one benchmark program purely by way of example.

The program part M1′ comprises a section M1a, which corresponds to M1 from FIG. 1, as well as a section M1b, which represents the benchmark program. When executed, the program part M1′ has a time of t1′. The same also applies to the other program parts M2′, . . . , M7′.

As a result of the introduction of the benchmark programs M1b, . . . , M7b, the resource utilization of individual components or program parts can be modified, in particular increased, by a defined value. In the simplest case the benchmark programs can be formed by means of wait loops which increase the duration of the execution of a program part by a defined amount.

The modifying of the program code of a program part does not need to be carried out for all program parts simultaneously. Rather, individual program parts can be modified sequentially, in which case it is beneficial to start first with those program parts that have the longest execution time.

If the source code of the program or of the program parts is fully accessible, the “artificial resource consumer” can also be incorporated at source code level. For a source code in Java, the aspect-oriented programming (AOP) approach is particularly suitable. In this case the factor analysis can be embodied as a separate “aspect” in which the “where” can easily be formulated as a so-called “pointcut” and the “what” and “how many” as what is called “advice”. “Where” means which program part is to be subjected to a modification and “what” means which resources (memory, runtime, inputs/outputs) are to be subjected to a modification. Aspect-oriented programming can also be used when the program is only available as bytecode. AspectJ permits the “weaving” of new, separate aspects with the bytecode of the application, of which only the interfaces need to be known. This is known to the person skilled in the art also as “bytecode weaving”.

Contrary to the expectation that the worsening of the resource utilization of one or more program parts also leads to a worsening of the resource utilization of the overall program, it has been demonstrated that in the end an improvement in the resource utilization of the overall system can be brought about in that in particular those program parts can be identified which have the greatest impact on the execution of the (overall) program. These program parts can then be subjected to a targeted optimization, for example.

By way of an embodiment of the invention it is possible in a single system test not only to determine the performance of a system in its entirety as well as in relation to the individual components, but also to quantify the degree to which the overall performance is dependent on the individual components. Components having a significant dependence can then be subjected in a targeted manner to an optimization process known as code refactoring.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for the computer-aided optimization of the resource utilization of a program comprising at least one separately executable program part when the program is executed on a computer system, the method comprising:
initially determining resource utilization during execution of the program;
extending the program code of the at least one separately executable program part by at least one benchmark program such that a change in the resource utilization of the program part results therefrom;
measuring the resource utilization of the program; and
varying the at least one benchmark program in the at least one separately executable program part and measuring the resource utilization of the program until a minimum resource utilization of the program is present.

2. The method as claimed in claim 1, wherein one or more of the following parameters is measured as a benchmark for the resource utilization:
the total runtime of the program;
a memory utilization of the computer system;
a usage of at least one of inputs and outputs; and
a utilization of at least one processing unit of the computer system.

3. The method as claimed in claim 1, wherein a runtime of the at least one program part is modified, in particular increased, by the at least one benchmark program.

4. The method as claimed in claim 1, wherein a utilization of the at least one processing unit is modified by the at least one benchmark program in the at least one program part.

5. The method as claimed in claim 1, wherein at least one of at least one input and one output of the distributed computer system is used by the at least one benchmark program in the at least one program part.

6. The method as claimed in claim 1, wherein a memory utilization of the distributed computer system caused by the at least one program part is modified by the at least one benchmark program in the at least one program part.

7. The method as claimed in claim 1, wherein the program code of the at least one program part is extended by at least one benchmark program at machine code level or at source code level.

8. The method as claimed in claim 1, wherein the extension of the program code of the at least one program part by at least one benchmark program starts with the program part having the relatively greatest runtime.

9. The method as claimed in claim 8, wherein the extension of the program code of the at least one program part by at least one benchmark program takes place sequentially.

10. The method as claimed in claim 1, wherein a profiling is carried out in order to at least one of determine the runtime of at least some of the program parts, determine a memory usage and determine a concurrency.

11. The method as claimed in claim 1, wherein the addition of the at least one benchmark program in the at least one program part is formed by the provisioning of an aspect.

12. The method as claimed in claim 1, wherein the resource utilization is determined by providing an aspect in a computer-aided manner.

13. The method of claim 1, wherein the program is executed on a distributed computer system.

14. The method as claimed in claim 3, wherein a runtime of the at least one program part is increased by the at least one benchmark program.

15. The method as claimed in claim 2, wherein a runtime of the at least one program part is modified by the at least one benchmark program.

16. The method as claimed in claim 15, wherein a runtime of the at least one program part is increased by the at least one benchmark program.

17. The method as claimed in claim 4, wherein a utilization of the at least one processing unit is increased by the at least one benchmark program in the at least one program part.

18. The method as claimed in claim 6, wherein a memory utilization of the distributed computer system caused by the at least one program part is increased by the at least one benchmark program in the at least one program part.
